(19) United States
(12) Patent Application Publication
(10) Pub. No.: US 2019/0102361 A1
(43) Pub. Date: Apr. 4, 2019

(54) AUTOMATICALLY DETECTING AND MANAGING ANOMALIES IN STATISTICAL MODELS

(71) Applicant: LinkedIn Corporation, Sunnyvale, CA (US)

(72) Inventors: Ajith Muralidharan, Sunnyvale, CA (US); Yiming Ma, Menlo Park, CA (US); Florian Raudies, Mountain View, CA (US); Yi Zhen, San Jose, CA (US)

(73) Assignee: LinkedIn Corporation, Sunnyvale, CA (US)

(21) Appl. No.: 15/721,359

(22) Filed: Sep. 29, 2017

(51) Int. Cl. G06F 17/18; G06F 17/30; G06Q 10/04

(52) U.S. Cl. CPC G06F 17/18; G06Q 10/04; G06F 17/30536

(57) ABSTRACT

The disclosed embodiments provide a system for managing the execution of a statistical model. During operation, the system tracks a distribution of one or more metrics related to a performance of a first version of a statistical model. When a deviation in the distribution is detected, the system outputs an alert of an anomaly in the performance of the statistical model. The system also triggers a rollback to a second version of the statistical model.

### BACKGROUND

### Field

The disclosed embodiments relate to data analysis. More specifically, the disclosed embodiments relate to techniques for automatically detecting and managing anomalies in statistical models.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

Consequently, creation and use of statistical models in analytics may be facilitated by mechanisms for improving the profiling, management, sharing, and reuse of features and/or statistical models.

### BRIEF DESCRIPTION OF THE FIGURES

FIG. 1 shows a schematic of a system in accordance with the disclosed embodiments.

FIG. 2 shows a system for monitoring and managing the execution of a statistical model in accordance with the disclosed embodiments.

FIG. 3 shows a flowchart illustrating a process of monitoring and managing the execution of a statistical model in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

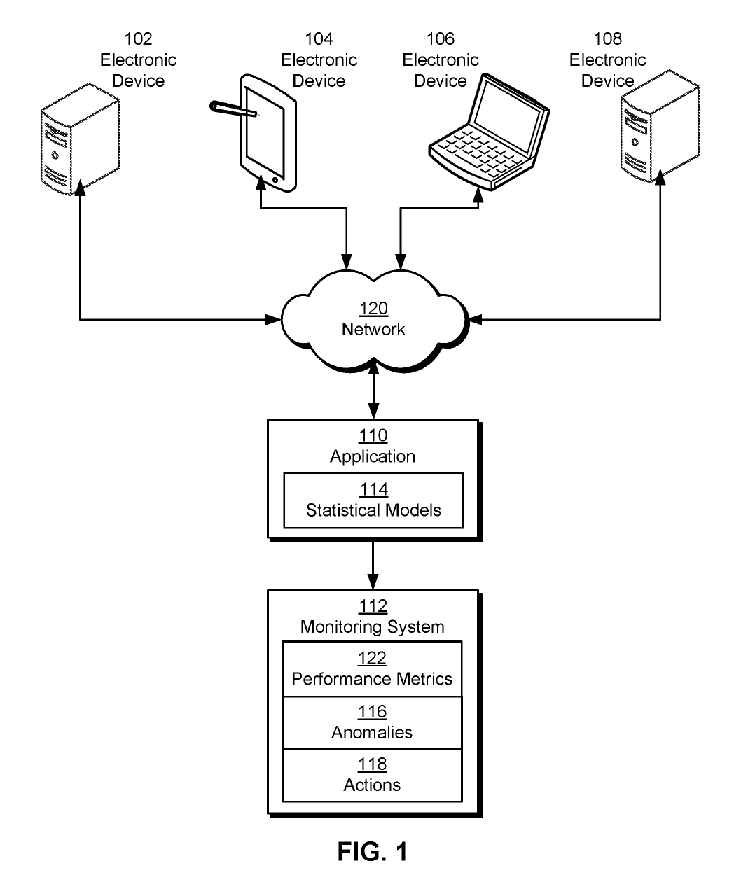

The disclosed embodiments provide a method, apparatus, and system for monitoring and/or managing the execution of statistical models. As shown in FIG. 1, a monitoring system 112 may monitor the execution of a set of statistical models 114 such as regression models, artificial neural networks, support vector machines, decision trees, naïve Bayes classifiers, Bayesian networks, random forests, gradient boosted trees, hierarchical models, and/or ensemble models.

Statistical models 114 may be used with and/or execute within an application 110 that is accessed by a set of electronic devices 102-108 over a network 120. For example, application 110 may be a native application, web application, one or more components of a mobile application, and/or another type of client-server application that is accessed over a network 120. In turn, electronic devices 102-108 may be personal computers (PCs), laptop computers, tablet computers, mobile phones, portable media players, workstations, gaming consoles, and/or other network-enabled computing devices that are capable of executing application 110 in one or more forms.

During use of application 110, users of electronic devices 102-108 may generate and/or provide data that is used as input to statistical models 114. Statistical models 114 may analyze the data to discover relationships, patterns, and/or trends in the data; gain insights from the input data; and/or guide decisions or actions related to the data.

For example, the users may use application 110 to access an online professional network and/or another type of social network. During use of application 110, the users may perform tasks such as establishing and maintaining professional connections; receiving and interacting with updates in the users' networks, professions, or industries; listing educational, work, and community experience; endorsing and/or recommending one another; listing, searching, and/or applying for jobs; searching for or contacting job candidates; providing business- or company-related updates; and/or conducting sales, marketing, and/or advertising activities. As a result, data that is inputted into statistical models 114 may include, but is not limited to, profile updates, profile views, connections, endorsements, invitations, follows, posts, comments, likes, shares, searches, clicks, conversions, messages, interactions with groups, address book interactions, response to recommendations, purchases, and/or other implicit or explicit feedback from the users. In turn, statistical models 114 may generate output that includes scores (e.g., connection strength scores, reputation scores, seniority scores, etc.), classifications (e.g., classifying users as job seekers or employed in certain roles), recommendations (e.g., content recommendations, job recommendations, skill recommendations, connection recommendations, etc.), estimates (e.g., estimates of spending), predictions (e.g., predictive scores, propensity to buy, propensity to churn, propensity to unsubscribe, etc.), and/or other inferences or properties.

On the other hand, the performance of statistical models 114 may deviate or degrade as the distribution, availability, presence, and/or quality of features inputted into statistical models 114 change over time. For example, the performance of a statistical model may drop in response to a drift in the distribution of features inputted into the statistical model and/or errors associated with generating the features. Such degraded or suboptimal performance in statistical models 114 may negatively impact the user experience with application 110 and/or the functionality of application 110.

In one or more embodiments, monitoring system 112 includes functionality to automatically detect and manage anomalies 116 in the performance of statistical models 114. More specifically, monitoring system 112 may compare the output of statistical models 114 with outcomes and/or labels associated with the input to produce a set of performance metrics 122. For example, the distribution of values outputted by each statistical model may be tracked over time using a mean, median, variance, count, sum, percentile, and/or other summary statistic. In another example, a recommendation, predicted action, and/or other output from each statistical model may be combined with a user's response to the recommendation, the user's actual action, and/or another outcome to calculate a receiver operating characteristic (ROC) area under the curve (AUC), observed/expected (O/E) ratio, and/or other performance metric for the statistical model.

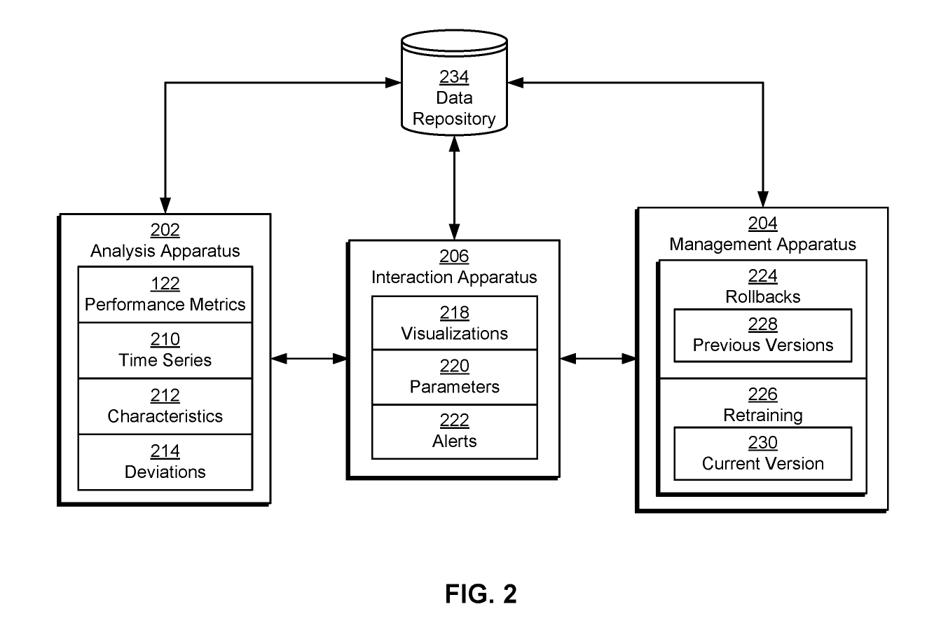

Next, monitoring system 112 may use performance metrics 122 to detect anomalies 116 and perform remedial actions 118 based on anomalies 116. As shown in FIG. 2, a system for monitoring and managing the execution of a statistical model (e.g., monitoring system 112 of FIG. 1) may include an analysis apparatus 202, a management apparatus 204, and an interaction apparatus 206. Each of these components is described in further detail below.

Analysis apparatus 202 may analyze the performance of one or more versions of a statistical model. The versions may include a current version 230 that is used to generate scores, predictions, classifications, estimates, recommendations, and/or other inferences on a real-time, near-real-time, and/or offline basis. In turn, the output of current version 230 may be used to supplement or perform real-world tasks such as managing the execution of an application, personalizing user experiences, managing relationships, making clinical decisions, carrying out transactions, operating autonomous vehicles or machines, and/or analyzing metrics or measurements.

The versions may also include one or more previous versions 228 of the statistical model. Previous versions 228 may include versions of the statistical model that were generated and/or used prior to current version 230. Thus, previous versions 228 may be trained using older data and/or techniques than current version 230 and/or use different features from current version 230.

The versions may optionally include one or more versions that are newer than current version 230. For example, the versions may include experimental versions of the statistical model and/or versions that were produced after current version 230 and undergoing training, validation, and/or testing.

While a given version (e.g., current version 230) of the statistical model is used in a live, production, or real-world environment, the output of the version may be collected and stored in a database, data store, distributed filesystem, messaging service, and/or another type of data repository 234. Outcomes, labels, and/or other measured values related to and/or used to verify the output of current version 230 may also be stored in data repository 234 and/or another data store.

Analysis apparatus 202 uses the output of current version 230 and the corresponding outcomes to assess the performance of the statistical model over time. More specifically, analysis apparatus 202 generates one or more performance metrics 122 from the output and corresponding outcomes.

For example, analysis apparatus 202 may bucketize values of an output propensity score collected from the statistical model over a prespecified period (e.g., 15 minutes, one hour, one day, etc.) into a predefined number of “bins.” Each propensity score may represent the likelihood of a given user interacting with (e.g., clicking or viewing) a given item (e.g., content item, recommendation, advertisement, etc.). The outcome associated with the propensity score may be specified using a Boolean that is set to 0 when the user does not interact with the item and 1 when the user interacts with the item. For each bin k, analysis apparatus 202 may calculate a performance metric as an O/E ratio using the following formula:

$$O \text{/} {E}_{k} = \frac{1}{n} {\sum }_{i = 1}^{n} i \text{/} Mean score$$

In the above formula, n represents the number of outcomes in k, i represents a given Boolean outcome in the bin, and “Mean score” represents the average propensity score in k.

Continuing with the above example, analysis apparatus 202 calculates a performance metric as a score distribution, in lieu of or in addition to the O/E ratio. To generate the score distribution, analysis apparatus 202 counts the number of propensity scores in each bin over the same period to produce a histogram of the frequencies of the propensity scores in the bins.

Next, analysis apparatus 202 tracks the distribution of performance metrics 122 over time by aggregating performance metrics 122 into one or more time series 210. For example, analysis apparatus 202 may use the O/E ratios, score distribution, and/or other performance metrics 122 calculated over each 15-minute period to produce a mean, variance, percentile, count, sum, and/or other summary statistics for performance metrics 122 that span the same period.

Analysis apparatus 202 then analyzes one or more characteristics 212 of time series 210 to detect deviations 214 in the distribution of performance metrics 122. For example, analysis apparatus 202 may decompose each time series 210 into characteristics 212 such as a trend component, a cyclical component, a seasonal component, and/or an irregular component. Analysis apparatus 202 may analyze individual components and/or the time series as a whole to detect deviations 214 outside of the distribution. The deviations may include, but are not limited to, outliers (e.g., individual values that lie outside of the distribution), mean shift (e.g., a significant change in the mean of the distribution), variance change (e.g., a significant change in the variance of the distribution), and/or trend change (e.g., a significant change in the trend component of the time series).

More specifically, analysis apparatus 202 may compare recent values of performance metrics 122 and/or time series 210 with historical or baseline values of performance metrics 122 and/or time series 210 to detect deviations 214. For example, an initial set of performance metrics 122 and/or time series 210 may be generated during A/B testing of current version 230 and/or ramping up of the statistical model to current version 230. The initial set may be used as a “baseline” of performance for current version 230 against which subsequent values of performance metrics 122 and/or time series 210 are compared. As current version 230 continues to execute, the latest performance metrics 122 and/or time series 210 are compared with older values (e.g., from the last day, week, two weeks, month, year, etc.) to detect deviations 214 as values that fall outside the historical or baseline distribution of performance metrics 122 and/or time series 122.

In one embodiment, when a deviation in the performance of current version 230 is found, management apparatus 204 automatically triggers retraining 226 of current version 230 using a newer set of features. Management apparatus 204 may simultaneously trigger and/or perform one or more rollbacks 224 to one or more previous versions 228 of the statistical model while retraining 226 of current version 230 is performed. For example, management apparatus 204 may use historical performance metrics 122 from data repository 234 and/or another repository to select a previous version with the best historical performance for use with a rollback of the statistical model from current version 230.

Management apparatus 204 may also, or instead, test the performance of multiple previous versions 228 of the statistical model and select, for use with the rollback, a previous version with the best performance among the set of previous versions 228. For example, management apparatus 204 may use a multi-armed bandit experiment, A/B test, and/or other sequential analysis or hypothesis testing technique to compare the performance of a set of previous versions 228 using live or up-to-date user traffic and/or other input features. At the conclusion of the experiment and/or test, management apparatus 204 may select the best-performing previous version for use in the rollback.

The experiment or test may be performed in an online basis (e.g., using real-time, live, and/or production data to make inferences in a production environment) and/or in an offline setting (e.g., by “replaying” historical data with the versions to identify a subset of high-performing versions). For example, an offline experiment may be used to select, from all previous versions 228 of the statistical model, a pre-specified number of previous versions that perform the best using recently collected input data. After a subset of best-performing previous versions is identified in the offline experiment, an online experiment or test may be used to select, based on performance metrics 122 generated from live or up-to-date input features, the single best-performing model from the subset for use in the rollback.

After the rollback from current version 230 to the selected previous version is performed, analysis apparatus 202 monitors performance metrics 122, time series 210, and/or characteristics 212 associated with the previous version. Analysis apparatus 202 may use the monitored data to compare the performance of the previous version with the past performance of current version 230 (e.g., before an anomaly or deviation is detected) and/or the historical performance of other previous versions 228. For example, analysis apparatus 202 may use an O/E ratio, ROC AUC, and/or another measure of sensitivity, specificity, accuracy, precision, and/or statistical model performance to determine if, after the rollback, the selected previous version is performing better or worse than current version 230 and/or other previous versions 228 have previously performed.

If the performance of the previous version is worse than the past performance of the current version and/or the historical performance of the previous version and/or other previous versions 228, management apparatus 204 may perform an additional rollback of the statistical model to another previous version. For example, management apparatus 204 may select, for the next rollback of the statistical model, a second previous version with the next highest historical performance. In another example, management apparatus 204 may select the second-best performing version from a multi-armed bandit experiment, A/B test, and/or other sequential analysis or hypothesis testing technique previously used to select the first previous version used in the first rollback. In a third example, management apparatus 204 may run another experiment and/or test to select, from remaining previous versions 228 of the statistical model, a new best-performing version for use in the next rollback.

Analysis apparatus 202 and management apparatus 204 may continue monitoring the performance of previous versions 228 associated with rollbacks 224 and/or performing additional rollbacks 224 based on the monitored performance during retraining 226 of current version 230. After retraining 226 is complete, the retrained current version 230 may be redeployed, and performance metrics 122, time series 210, and characteristics 212 may be monitored to detect deviations 214 and/or degraded performance in the redeployed current version 230. If current version 230 continues to exhibit anomalies and/or perform worse than one or more previous versions 228, a rollback to a better performing previous version may be performed on a more permanent basis (e.g., until a new version of the statistical model can be created).

Similarly, retraining 226 of current version 230 may be unavailable due to a lack of input features and/or an unavailability of a model retraining system. In this instance, a rollback to one or more previous versions 228 may also be carried out on a more permanent basis.

While analysis apparatus 202 and management apparatus 204 monitor and manage the performance of the statistical model, interaction apparatus 206 generates output related to the operation of analysis apparatus 202, management apparatus 204, and/or other components of the system. In one embodiment, the output includes one or more visualizations 218 associated with performance metrics 122, time series 210, characteristics 212, deviations 214, and/or other data generated or maintained by analysis apparatus 202 and/or management apparatus 204. For example, visualizations 218 may include tables, spreadsheets, line charts, bar charts, histograms, pie charts, and/or other representations of data related to performance metrics 122, time series 210, characteristics 212, rollbacks 224, and/or model retraining 226.

Visualizations 218 may also be generated and/or updated based on one or more parameters 220. For example, interaction apparatus 206 may enable filtering, sorting, and/or grouping of data in visualizations 218 by values and/or ranges of values associated with performance metrics 122, time series 210, characteristic 212, deviations 214, previous versions 228, and/or current version 230.

Finally, interaction apparatus 206 generates and/or outputs alerts 222 related to deviations 214, rollbacks 224, current version 230, and/or previous versions 228. Alerts 222 may be transmitted via email, notifications, messages, and/or other communications mechanisms to administrators, developers, data scientists, researchers, and/or other users associated with developing and/or maintaining the statistical model and/or any applications that use or depend on the statistical model.

First, interaction apparatus 206 may output an alert of an anomaly in the statistical model whenever deviations 214 and/or degradation are detected in performance metrics 122, time series 210, and/or characteristics 212 of the currently deployed or rolled back version of the statistical model. The alert may include values and/or attributes associated with the anomaly, such as the type of deviation (e.g., mean shift, variance change, trend change, outlier, etc.), the magnitude of deviation (e.g., the amount by which the deviation differs from a “normal” or expected value), and/or a timeframe of each deviation (e.g., the start and/or end times of the deviation).

Second, interaction apparatus 206 may generate one or more alerts of each rollback, test, and/or experiment performed after an anomaly or degradation is detected in a deployed version of the model. The alert may include the cause of the rollback, test, and/or experiment (e.g., the model version or type of degradation that triggered the rollback); the model versions involved in the rollback, test, and/or experiment; the start and/or end times of the rollback, test and/or experiment; and/or the result of the rollback, test or experiment.

Third, interaction apparatus 206 may output an alert of degraded performance across a series of statistical model versions (e.g., current version 230 and/or one or more previous versions 228 used in rollbacks 224). The alert may identify the affected statistical model versions, one or more time periods in which the degraded performance is detected, and/or the type or magnitude of the degradation.

Fourth, interaction apparatus 206 may output an alert when current version 230 and/or previous versions 228 exceed a predefined age (e.g., a certain number of days, weeks, etc.). In turn, recipients of the alert may initiate manual retraining 226 of one or more versions of the statistical model and/or generate a new version of the statistical model.

By continuously monitoring the output and/or performance of online, offline, and/or nearline versions of a statistical model, analysis apparatus 202 may quickly detect degradation and/or anomalies in the statistical model without requiring manual user intervention or analysis. At the same time, management apparatus 204 may automatically perform remedial actions, such as retraining 226 and/or rollbacks 224, to mitigate or resolve such degradation or anomalies, and interaction apparatus 206 may generate output to facilitate subsequent planning, analysis, or intervention by humans. Consequently, the system of FIG. 2 may improve the performance and use of statistical models and/or applications, distributed systems, and/or other technologies that use or leverage statistical models.

Those skilled in the art will appreciate that the system of FIG. 2 may be implemented in a variety of ways. First, analysis apparatus 202, management apparatus 204, interaction apparatus 206, and/or data repository 234 may be provided by a single physical machine, multiple computer systems, one or more virtual machines, a grid, one or more databases, one or more filesystems, and/or a cloud computing system. Analysis apparatus 202, management apparatus 204, and interaction apparatus 206 may additionally be implemented together and/or separately by one or more hardware and/or software components and/or layers. Moreover, various components of the system may be configured to execute in an offline, online, and/or nearline basis to perform different types of processing related to anomaly detection, management, monitoring, retraining, and/or rollback for statistical models.

Second, different types of performance metrics 122 may be tracked and used to detect and manage anomalies in current version 230 and/or previous versions 228 of the statistical model. For example, performance metrics 122 may include fractional bias, ROC AUC, normalized mean squared error, Brier score, and/or other measures of statistical model performance or output.

Third, a number of techniques may be used to identify deviations 214, degradation, and/or anomalies in the statistical model. For example, analysis apparatus 202 may use a sign test, student's t-test, z-statistic, and/or another statistical hypothesis test to detect deviations 214 in the distribution and/or variance of performance metrics 122 and/or time series 210 from the corresponding baseline and/or historical values. In another example, statistical techniques such as support vector machines, neural networks, and/or clustering techniques may be used to identify deviations 214 and/or anomalies in performance metrics 122 and/or time series 210.

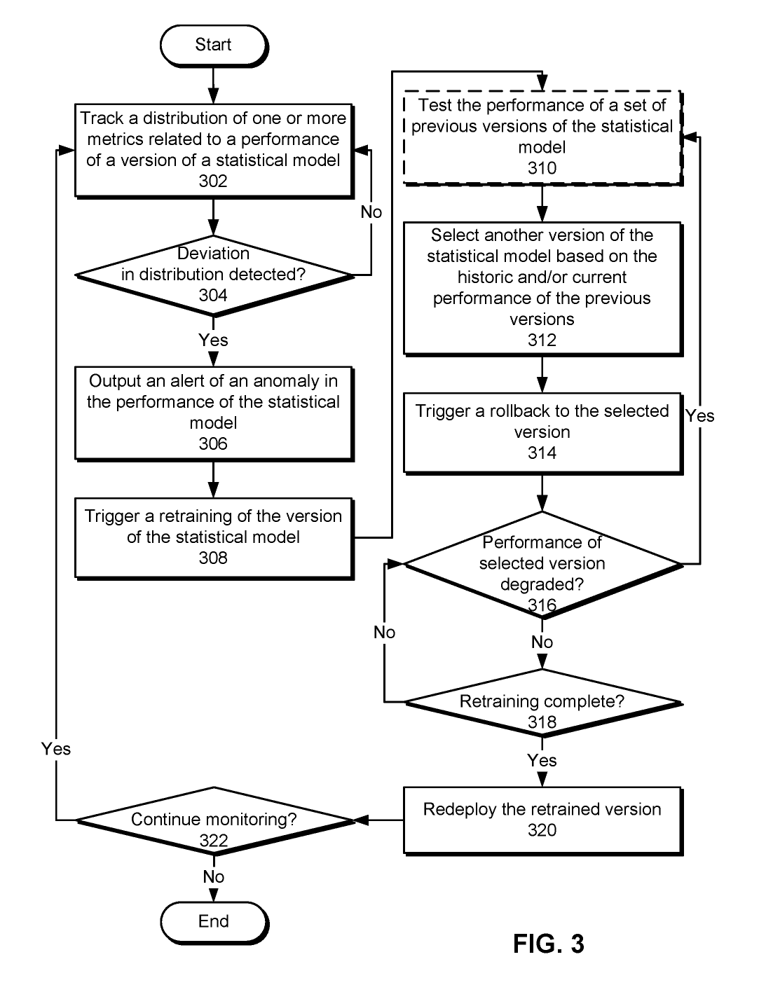

FIG. 3 shows a flowchart illustrating a process of monitoring and managing the execution of a statistical model in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a distribution of one or more metrics related to a performance of a version of a statistical model is tracked (operation 302). For example, the metrics may include an O/E ratio, score distribution, and/or other measurement of output, precision, accuracy, sensitivity, specificity, and/or performance of the statistical model. The metrics may be aggregated into a time series using summary statistics such as a mean, variance, percentile, count, and/or sum. One or more characteristics and/or components (e.g., trend, seasonal, cyclical, and/or irregular components) of the time series may then be analyzed to characterize the distribution of the metrics over time.

During tracking of the distribution, a deviation in the distribution may be detected (operation 304). For example, the deviation may be detected as a mean shift, variance change, trend change, and/or outlier in the time series. In turn, the deviation may indicate a change (decrease or increase) in the performance of the statistical model. If no deviation is detected, the distribution may continue to be tracked (operation 302).

Once a deviation in the distribution is detected, an alert of an anomaly in the performance of the statistical model is outputted (operation 306), and a retraining of the version is triggered (operation 308). While the retraining occurs, a rollback to a previous version of the statistical model is performed. The rollback may be initiated by optionally testing the performance of a set of previous versions of the statistical model (operation 310). For example, a subset of previous and/or additional versions of the statistical model may be selected for inclusion in an A/B test and/or multi-armed bandit experiment based on offline analysis of the previous versions' performance with recent input features to the statistical model and/or the historical performance of the previous versions. The A/B test and/or multi-armed bandit experiment may then be conducted to determine the performance of the selected subset of previous versions in a live and/or real-world setting (e.g., by splitting user or network traffic among the selected versions).

Next, another version of the statistical model is selected for use in the rollback based on the historical and/or current performance of the previous versions (operation 312). Continuing with the previous example, the best-performing version in the experiment and/or test may be selected at the conclusion of the experiment and/or test. In an alternative example, the version may be selected to have the best historical performance among the set of previous versions instead of requiring the use of a statistical hypothesis test and/or sequential analysis technique to identify the best-performing previous version.

After a previous version of the statistical model is selected for use in the rollback, the rollback to the selected version is triggered (operation 314). For example, the selected version may be deployed in a production environment, and network traffic and/or other input data may be directed to the selected version. In another example, the selected version may be used in an offline- or batch-processing environment to generate scores, estimates, predictions, and/or other inferences that are used with a production application on an hourly, daily, weekly, and/or other periodic basis. An alert of the rollback may also be generated.

After the rollback is performed, the performance of the selected version may be monitored for degradation (operation 316). For example, performance metrics of the selected version may be monitored and compared with the recent, pre-anomaly performance of the current version and/or the historical performance of other previous versions of the statistical model. Degraded performance in the selected version may be detected when the current performance of the selected version is lower than the recent performance of the current version and/or the historical performance of the other previous versions.

If the performance of the rolled back version is degraded, another rollback to a different previous version of the statistical model may be performed (operations 309-314), and the performance of the version used in the rollback may be monitored for degradation (operation 316). Thus, monitoring and use of previous versions of the statistical model may continue until retraining of the current version is complete (operation 318) and the current version is redeployed (operation 320).

General monitoring of the statistical model may continue (operation 322) during use of the statistical model to perform inference in a live, production, and/or real-world setting. For example, the performance of the statistical model may continue to be monitored and managed during use of the statistical model to generate scores, recommendations, predictions, estimates, and/or inferences related to users, schools, companies, connections, jobs, skills, industries, and/or other features or attributes in an online professional network.

During monitoring of the statistical model, the distribution of performance metrics for a given version of the statistical model is tracked (operation 302) to detect deviations in the distribution (operation 304). If a deviation is found, an alert of an anomaly in the statistical model's performance is outputted (operation 306), and retraining of the version is triggered (operation 308). Rollback of the statistical model to one or more previous versions is also performed (operations 310-314) and monitored (operation 316) until retraining is complete (operation 318) and the retrained version is redeployed (operation 320). Such automatic monitoring and management of anomalies in the statistical model may be performed until the statistical model is no longer used.

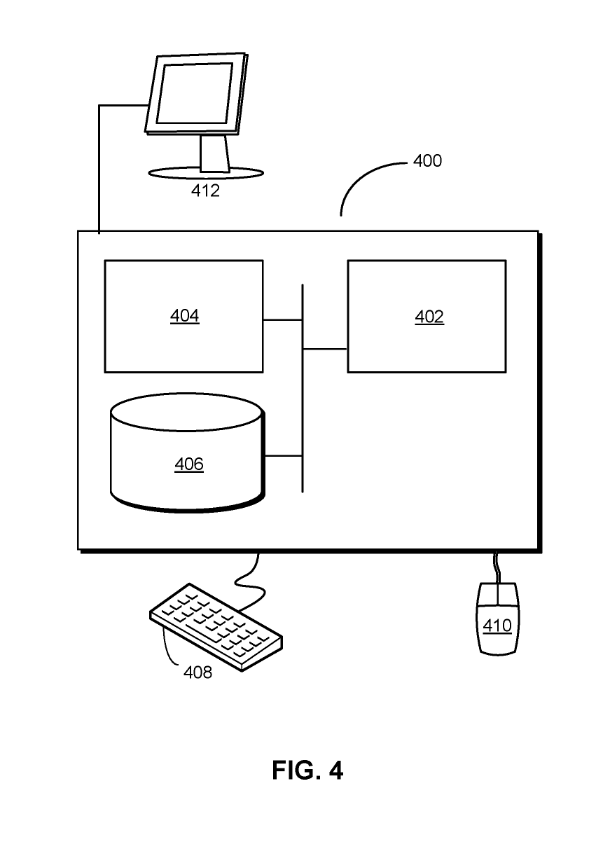

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for managing the execution of a statistical model. The system may include an analysis apparatus, an interaction apparatus, and a management apparatus, one or more of which alternatively be termed or implemented as a module, mechanism, or other type of system component. The analysis apparatus may track a distribution of one or more metrics related to a performance of a first version of a statistical model. When a deviation in the distribution is detected, the interaction apparatus may output an alert of an anomaly in the performance of the statistical model. The management apparatus may also trigger a rollback to a second version of the statistical model and/or a retraining of the first version.

In addition, one or more components of computer system 400 may be remotely located and connected to the other components over a network. Portions of the present embodiments (e.g., analysis apparatus, management apparatus, interaction apparatus, data repository, etc.) may also be located on different nodes of a distributed system that implements the embodiments. For example, the present embodiments may be implemented using a cloud computing system that detects and manages anomalies in a set of remote statistical models.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
tracking, by a computer system, a distribution of one or more metrics related to a performance of a first version of a statistical model; and
determining a change in a performance of the first version of the statistical model based on a deviation in the distribution;
responsive to determining the change in the performance of the current version, selecting a second version of the statistical model from a set of additional versions of the statistical model; and
triggering a rollback to the second version of the statistical model.

2. The method of claim 1, further comprising:
after the rollback is performed, tracking an additional distribution of the one or more metrics related to the performance of the second version of the statistical model; and
when the additional distribution indicates degradation in the performance of the first previous version, triggering an additional rollback to a third version of the statistical model.

3. The method of claim 2, further comprising:
outputting an alert of the rollback, the additional rollback, and the performance of the first and second versions of the statistical model.

4. The method of claim 1, further comprising:
selecting the second version of the statistical model based on a historical performance of the second version.

5. The method of claim 1, further comprising:
after the deviation in the distribution is detected, testing the performance of a set of previous versions of the statistical model; and
selecting the second version of the statistical model to have a best performance among the set of previous versions.

6. The method of claim 1, wherein tracking the distribution of the one or more metrics comprises:
aggregating the one or more metrics into a time series; and
analyzing one or more characteristics of the time series.

7. The method of claim 6, wherein the time series comprises at least one of:
a mean;
a variance;
a percentile;
a count; and
a sum.

8. The method of claim 6, wherein the one or more characteristics of the time series comprise at least one of:
a trend component;
a seasonal component;
a cyclical component; and
an irregular component.

9. The method of claim 1, wherein the deviation in the distribution comprises at least one of:
a mean shift;
a variance change;
a trend change; and
an outlier.

10. The method of claim 1, further comprising:
triggering a retraining of the first version of the statistical model after the deviation in the distribution is detected; and
after the retraining is complete, redeploying the first version of the statistical model.

11. The method of claim 1, wherein the one or more metrics comprises an observed/expected (O/E) ratio.

12. The method of claim 1, wherein the one or more metrics comprises a score distribution.

13. An apparatus, comprising:
one or more processors; and
memory storing instructions that, when executed by the one or more processors, cause the apparatus to:
track a distribution of one or more metrics related to a performance of a first version of a statistical model;
determine a change in a performance of the first version of the statistical model based on a deviation in the distribution;
responsive to determining the change in the performance of the current version, selecting a second version of the statistical model from a set of additional versions of the statistical model; and
triggering a rollback to a second version of the statistical model.

14. The apparatus of claim 13, wherein the memory further stores instructions that, when executed by the one or more processors, further cause the apparatus to:
after the rollback is performed, track an additional distribution of the one or more metrics related to the performance of the second version of the statistical model; and
when the additional distribution indicates degradation in the performance of the first previous version, trigger an additional rollback to a third version of the statistical model.

15. The apparatus of claim 13, wherein the memory further stores instructions that, when executed by the one or more processors, further cause the apparatus to:
select the second version of the statistical model based on a historical performance of the second version.

16. The apparatus of claim 13, wherein the memory further stores instructions that, when executed by the one or more processors, further cause the apparatus to:
after the deviation in the distribution is detected, test the performance of a set of previous versions of the statistical model; and
select the second version of the statistical model to have a best performance among the set of previous versions.

17. The apparatus of claim 13, wherein tracking the distribution of the one or more metrics comprises:
aggregating the one or more metrics into a time series; and
analyzing one or more characteristics of the time series.

18. The apparatus of claim 13, wherein the memory further stores instructions that, when executed by the one or more processors, further cause the apparatus to:
trigger a retraining of the first version of the statistical model after the deviation in the distribution is detected; and
after the retraining is complete, redeploy the first version of the statistical model.

19. A non-transitory computer-readable storage medium storing instructions that when executed by a computer cause the computer to perform a method, the method comprising:
tracking a distribution of one or more metrics related to a performance of a first version of a statistical model; and
determining a change in a performance of the first version of the statistical model based on a deviation in the distribution;
responsive to determining the change in the performance of the current version, selecting a second version of the statistical model from a set of additional versions of the statistical model; and
triggering a rollback to the second version of the statistical model.

20. The non-transitory computer-readable storage medium of claim 19, the method further comprising:
triggering a retraining of the first version of the statistical model after the deviation in the distribution is detected; and
after the retraining is complete, redeploying the first version of the statistical model.
